(19) United States
(12) Patent Application Publication
(10) Pub. No.: US 2021/0282033 A1
(43) Pub. Date: Sep. 9, 2021

(54) POSITIONING SYSTEM FOR INTEGRATING MACHINE LEARNING POSITIONING MODELS AND POSITIONING METHOD FOR THE SAME

(71) Applicant: PSJ INTERNATIONAL LTD., Tortola (VG)

(72) Inventors: ALEXANDER I CHI LAI, Taipei City (TW); Ruey-Beei Wu, Taipei City (TW)

(21) Appl. No.: 17/136,232

(22) Filed: Dec. 29, 2020

Related U.S. Application Data
(60) Provisional application No. 62/986,781, filed on Mar. 9, 2020.

(51) Int. Cl. H04W 24/06; H04W 64/00; H04B 17/318; G06N 20/00

(52) U.S. Cl. CPC H04W 24/06; G06N 20/00; H04B 17/318; H04W 64/003

(57) ABSTRACT

A positioning system for integrating machine learning positioning models and a positioning method for the same are provided. The positioning system includes a DUT (device under test) and a scalable backend subsystem. The DUT obtains current WI-FI® fingerprint data. The scalable backend subsystem communicates with the DUT, and includes a database server, a processing unit, a plurality of machine learning positioning service modules, and a DUT service module. The database server stores a plurality of records of machine learning positioning model data, configuration data and setting data defining a positioning inference path. The DUT service module includes a positioning inference module, the positioning inference module receives the current WI-FI® fingerprint data, and sequentially inputs the current WI-FI® fingerprint data into the machine learning positioning service modules according to the positioning inference path to sequentially obtain and integrate multiple positioning inference results so as to generate positioning results.

### CROSS-REFERENCE TO RELATED PATENT APPLICATION

This application claims priority to the U.S. Provisional Patent Application Ser. No. 62/986,781 filed on Mar. 9, 2020, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a positioning system and a positioning method, and more particularly to a positioning system for integrating machine learning positioning models and a positioning method for the same.

### BACKGROUND OF THE DISCLOSURE

With an expansion of mobile computing nodes and advancement of wireless technology, demands for accurate indoor positioning and related services have become more and more popular. A reliable and accurate indoor positioning can support a wide range of applications.

However, current indoor positioning systems have many issues, for example, these systems are often imprecise, too complex to implement, and/or too expensive. An indoor positioning system based on WI-FI® and received signal strength index (RSSI) signals has high accuracy, however, the number of WI-FI® signals may be too large in the same field, and complexity and change rates thereof are large. Therefore, it is difficult to establish an accurate positioning system purely based on WI-FI® signals and signal strengths.

In addition, when the field that utilizes the current indoor positioning systems is too large, the time required for positioning is extended and the system computing resources used is increased, without the corresponding accuracy being improved. Therefore, there is an urgent need in the art for a positioning system and a method integrating multiple machine learning positioning models.

### SUMMARY OF THE DISCLOSURE

In response to the above-referenced technical inadequacies, the present disclosure provides a positioning system for integrating machine learning positioning models and a positioning method for the same.

In one aspect, the present disclosure provides a positioning system for integrating machine learning positioning models, which includes a device under test (DUT) and a scalable backend subsystem. The device under test is configured to obtain current WI-FI® fingerprint data of a current location. The scalable backend subsystem is configured to communicate with the DUT, and includes a database server, at least one processing unit, a plurality of machine learning positioning service modules, and a DUT service module. The database server is configured to store a plurality of records of machine learning positioning model data, configuration data and setting data, and the setting data defines a positioning inference path. The plurality of machine learning positioning service modules are generated by the at least one processing unit executing the plurality of records of machine learning positioning model data, the positioning inference path defines a fetching sequence of the plurality of machine learning positioning service modules, and the configuration data defines a deployment status of the plurality of machine learning positioning service modules. The DUT service module includes a positioning inference module. The positioning inference module is configured to receive the current WI-FI® fingerprint data, and sequentially input the current WI-FI® fingerprint data to the plurality of machine learning positioning service modules according to the positioning inference path, to sequentially obtain a plurality of positioning inference results, and the DUT service module integrates the plurality of positioning inference results to generate a positioning result, and uses the positioning result as the current position of the DUT.

In some embodiments, the scalable backend subsystem further includes a management service module, which includes a web server and a deployment service module. The web server includes a user interface. The deployment service module includes a creation unit, a reading unit, an updating unit, and a deletion unit. The creation unit is configured for the user to deploy a new machine learning positioning model, and store a configuration file related to the new machine learning positioning model to the database server. The reading unit is configured to obtain the deployment status of the plurality of machine learning positioning service modules from the configuration data. The updating unit is configured to update the plurality of machine learning positioning service modules based on the new machine learning positioning model, and update the configuration data with the configuration file. The deletion unit is configured for the user to delete the machine learning positioning model services.

In some embodiments, the management service module further includes a setting module configured for the user to set the positioning inference path based on the new machine learning positioning model and update the setting data.

In some embodiments, the management service module further includes a signal detection module configured to determine whether or not at least one specific signal has appeared in the current WI-FI® fingerprint data, thereby narrowing the plurality of positioning inference results based on a specific range associated to the at least one specific signal.

In some embodiments, the user interface is configured for the user to upload the new machine learning positioning model to the web server.

In some embodiments, the plurality of machine learning positioning service modules respectively correspond to a plurality of application ranges, and the positioning inference path is planned according to the plurality of application ranges.

In some embodiments, the plurality of application ranges includes a plurality of buildings, a plurality of floors corresponding to each of the buildings, and a plurality of areas corresponding to each of the floors.

In some embodiments, each of the plurality of machine learning positioning service modules includes a trained machine learning positioning model, and has a higher accuracy for corresponding ones of the plurality of application ranges.

In some embodiments, each of the plurality of machine learning positioning service modules includes an access point selection module configured to filter the current WI-FI® fingerprint data according to a plurality of access point sensing ratio and input the filtered current WI-FI® fingerprint data to the corresponding trained machine learning positioning model.

In another aspect, the present disclosure provides a positioning method for integrating machine learning positioning models, the positioning method includes: configuring a device under test (DUT) to obtain current WI-FI® fingerprint data of a current location; configuring a scalable backend subsystem to communicate with the DUT, in which the scalable backend subsystem includes a web server, a database server and at least one processing unit; configuring the database server to store a plurality of records of machine learning positioning model data, configuration data and setting data, in which the setting data defines a positioning inference path; configuring the at least one processing unit to execute the plurality of records of machine learning positioning model data to generate a plurality of machine learning positioning service modules, in which the positioning inference path defines a fetching sequence of the plurality of machine learning positioning service modules, and the configuration data defines a deployment status of the plurality of machine learning positioning service modules; configuring a positioning inference module of a DUT service module to receive the current WI-FI® fingerprint data, and sequentially input the current WI-FI® fingerprint data to the plurality of machine learning positioning service modules according to the positioning inference path, to sequentially obtain a plurality of positioning inference results, respectively; and configuring the DUT service module to integrate the plurality of positioning inference results to generate a positioning result and use the positioning result as the current position of the DUT.

Therefore, the positioning system for integrating machine learning positioning models and the method for the same provided by the present disclosure can perform modular management for multiple machine learning positioning models, and perform hierarchical positioning according to the positioning inference path to fetch multiple machine learning positioning models suitable for different positioning ranges, such that a positioning accuracy can be improved, and time required for calculation can be reduced.

In addition, the positioning system for integrating machine learning positioning models and the positioning method for the same provided by the present disclosure also includes a deployment service module, which provides a concise way for the user to apply functions of creation, reading, updating, and deletion through the user interface on multiple machine learning positioning models to be deployed, thereby reducing the time and labor costs required to deploy different machine learning positioning models.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a block diagram of a positioning system for integrating machine learning positioning models according to an embodiment of the present disclosure.

FIG. 2 is a block diagram showing a management service module and a database server according to an embodiment of the present disclosure.

FIG. 3 is a flowchart of a deployment process according to an embodiment of the present disclosure.

FIG. 4 is a flowchart of a positioning process according to an embodiment of the present disclosure.

FIG. 5 is a flowchart of a training process for a machine learning positioning service module according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural references, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

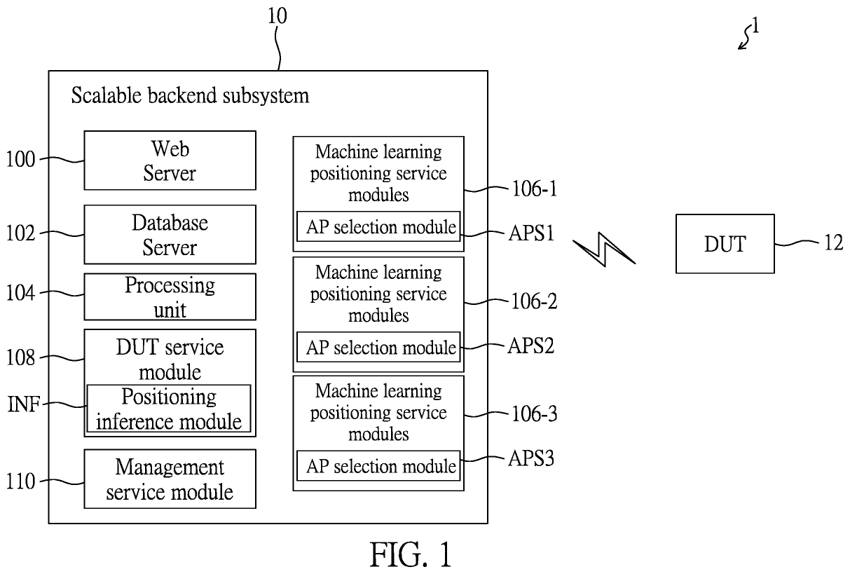

FIG. 1 is a block diagram of a positioning system for integrating machine learning positioning models according to an embodiment of the present disclosure. Reference is made to FIG. 1, an embodiment of the present disclosure provides a positioning system 1 for integrating machine learning positioning models, and the positioning system 1 includes a scalable backend subsystem 10 and a device under test (DUT) 12.

The DUT 12 can be configured to obtain current WI-FI® fingerprint data of a current location. In detail, the DUT 12 is configured to collect WI-FI® fingerprint data at a current location thereof in a target area. The DUT 12 can include a wireless transceiver to receive and transmit signals, and the DUT 12 can be, for example, a mobile device such as a tablet computer, a mobile phone, or a proprietary hardware platform. In detail, the DUT 12 is mainly configured to utilize a detected number of WI-FI® access points, received signal strength indicators (RSSIs) of detectable WI-FI® access points, channel information of detectable WI-FI® access points, characteristic information generated during a communication process with the detected WI-FIR access point, to generate WI-FI® fingerprints.

However, not all embodiments are limited to the above fingerprint technology, and other WI-FI® positioning technologies can also be used to simultaneously mix data from various radio sources, such as combined WI-FI®, radio frequency identification (RFID), wireless BLUETOOTH® transmission of data, or ultra-wideband (UWB) ranging module, and non-wireless radio frequency (RF) signal data can also be combined, such as signal data from inertial measurement unit and environmental measurement unit.

In some embodiments, the DUT 12 may be, for example, a mobile device, which includes a processing unit (for example, a processor), a storage unit (for example, flash memory) and a transceiver unit (for example, a WI-FI® module supporting 2.4G/5G frequency band) electrically connected to the processing unit.

The scalable backend subsystem 1 can be configured to communicate with the DUT 12, and includes a web server 100, a database server 102, a processing unit 104, and a plurality of machine learning positioning service modules 106-1, 106-2 and 106-3, a DUT service module 108, and a management service module 110.

The scalable backend subsystem 10 can include any suitable processor-driven computing devices, including, but not limited to, desktop computing devices, laptop computing devices, servers, smart phones, tablet computers, and the like. The processing unit 104 can be an integrated circuit such as a programmable logic controller circuit, a micro-processor circuit, or a micro-control circuit, or an electronic device including the aforementioned integrated circuit, such as tablet computers, mobile phones, notebook computers or desktop computers, and the like, but the present disclosure is not limited thereto.

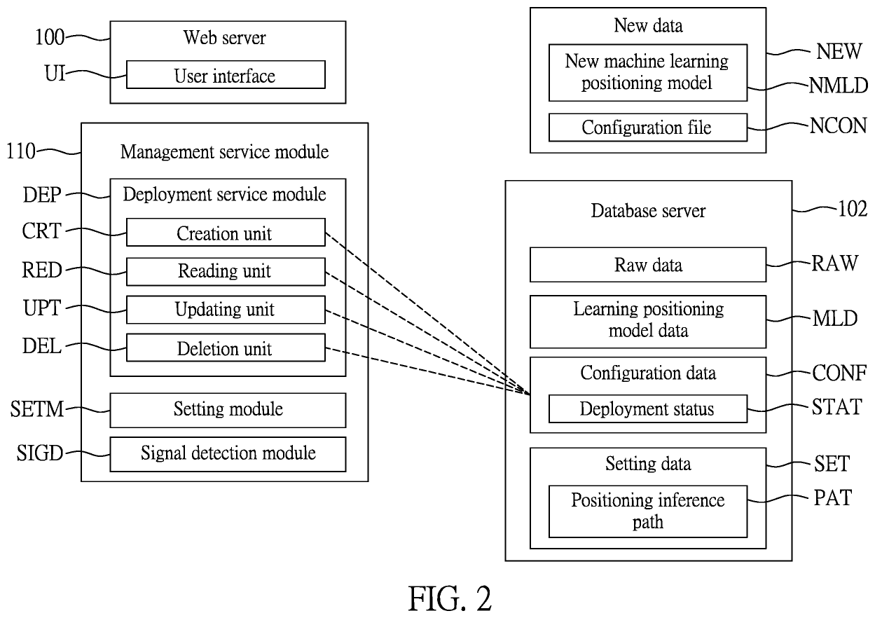

Reference can be further made to FIG. 2, which is a block diagram showing a management service module and a database server according to an embodiment of the present disclosure. As shown in FIG. 2, the database server 102 is configured to store raw data RAW, a plurality of records of learning positioning model data MLD, configuration data CONF, and setting data SET. The setting data SET defines a positioning inference path PAT. The raw data RAW can include processing programs for realizing each modules in the scalable backend subsystem 1, and positioning map data for positioning in a target area. The positioning map data can include a plurality of records of WI-FI® fingerprint data corresponding to a plurality of collection points in the target area. The database server 102 can include, for example, a memory system, which can include non-volatile memory (such as flash memory) and system memory (such as DRAM).

Reference is made to FIG. 1, in conjunction with FIG. 2, the machine learning positioning service modules 106-1, 106-2, and 106-3 can be generated by the processing unit 104 executing the plurality of records of machine learning positioning model data MLD. The positioning inference path PAT defines a fetching sequence of the machine learning positioning service modules 106-1, 106-2, and 106-3, and the configuration data CONF defines a deployment status STAT of the machine learning positioning service modules 106-1, 106-2, and 106-3. It should be noted that, in this embodiment, the number of machine learning positioning service modules 106-1, 106-2, and 106-3 is only an example, and the number can be at least two or more, and the present disclosure is not limited thereto.

In addition, as shown in FIG. 2, the web server 100 includes a user interface UI, and the management service module 110 can include a deployment service module DEP. The deployment service module DEP includes a creation unit CRT, a reading unit RED, an updating unit UPT, and a deletion unit DEL.

In detail, a user can access the creation unit CRT, the reading unit RED, the updating unit UPT and the deletion unit DEL through the user interface UI of the web server 100 to perform functions of creation, reading, updating and deletion on the machine learning positioning service modules 106-1, 106-2 and 106-3. In this case, the user can provide a new record of data NEW, including a new machine learning positioning model NMLD and its corresponding configuration file NCON, and the creation unit CRT can be used for the user to deploy the new machine learning positioning model NMLD, and store the configuration file NCON associated to the new machine learning positioning model NMLD in the database server 102.

In addition, the reading unit RED can be used to obtain the deployment status STAT of the machine learning positioning service modules 106-1, 106-2, and 106-3 from the configuration data CONF. The update unit UPT can update the machine learning positioning service modules 106-1, 106-2, and 106-3 based on the new machine learning positioning model NMLD, and update the configuration data CONF with the configuration file NCON. The deletion unit DEL can be used by the user to delete the machine learning positioning model services 106-1, 106-2, and 106-3.

In this embodiment, the management service module 110 further includes a setting module SETM, which is provided for the user to set the positioning inference path PAT based on the new machine learning positioning model NMLD and update the setting data SET.

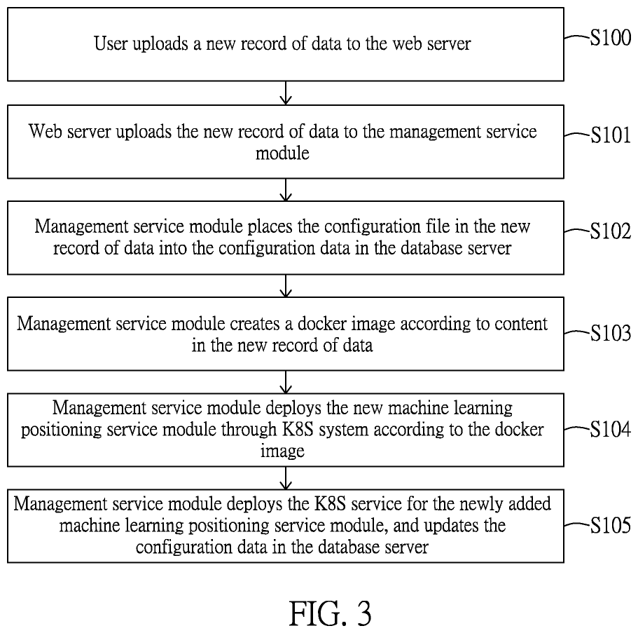

Therefore, the above-mentioned new machine learning positioning model NMLD can be deployed through a deployment process. Reference is made to FIG. 3, which is a flowchart of a deployment process according to an embodiment of the present disclosure. As shown in FIG. 3, the deployment process can include the following steps:

Step S100: the user uploads a new record of data NEW to the web server 100. The new record of data NEW can be, for example, a compressed file in zip format, and can include JavaScript Object Notation (JSON) data, which presents the configuration file NCON and the new machine learning positioning model NMLD as structured data in a standard format of JavaScript object.

Step S101: the web server 100 uploads the new record of data NEW to the management service module 110.

Step S102: The management service module 110 places the configuration file NCON in the new record of data NEW into the configuration data CONF in the database server 102.

Step S103: The management service module 110 creates a docker image according to content in the new record of data NEW.

Step S104: The management service module 110 deploys the new machine learning positioning service module through a Kubernetes® (K8S) system according to the docker image. The Kubernetes® (K8S) system can be used to manage microservices, and can automatically deploy and manage multiple containers on multiple machines. For example, the Kubernetes® (K8S) system can deploy the multiple containers to the multiple machines at the same time, and when loading capacities of services provided by the multiple machines change, the Kubernetes® (K8S) system can automatically scale the containers, manage statuses of the multiple containers, and automatically detect and restart a failed container. Furthermore, the aforementioned machine learning positioning model services 106-1, 106-2, and 106-3 essentially exist in the scalable backend subsystem 1 in forms of containers to facilitate deployment, scale, and management.

Step S105: The management service module 110 deploys a K8S service for the newly added machine learning positioning service module, and updates the configuration data CONF in the database server 102.

Therefore, the above deployment service module DEP can provide users with a concise way through the user interface to apply functions of creation, reading, updating, and deletion on multiple machine learning positioning models to be deployed, thereby reducing the time and labor costs required to deploy different machine learning positioning models.

Reference is further made to FIG. 1, and the DUT service module 108 is then described hereinafter. The DUT service module 108 includes a positioning inference module INF configured to receive the current WI-FI® fingerprint data and sequentially input the current WI-FI® fingerprint data into the machine learning positioning service modules 106-1, 106-2 and 106-3 according to the positioning inference path PAT, to sequentially obtain a plurality of positioning inference results. The DUT service module integrates the positioning inference results to generate the positioning result, and uses the positioning result as the current location of the DUT 12.

In detail, the machine learning positioning service modules 106-1, 106-2, and 106-3 respectively correspond to a plurality of application ranges, and the positioning inference path is planned according to the application ranges. Each of the machine learning positioning service modules 106-1, 106-2, and 106-3 includes a trained machine learning positioning model, and has a higher accuracy for corresponding ones of the plurality of application ranges.

For example, the above-mentioned application ranges can be generated by dividing a target area, including by using a layered manner. For example, for a target area that includes a plurality of buildings, the plurality of buildings can be used as a first layer. A plurality of floors corresponding to each of the plurality of buildings can be used as a second layer, and a plurality of areas corresponding to each of the floors can be used as a third layer. The machine learning positioning service modules 106-1, 106-2 and 106-3 can include: (1) a trained machine learning positioning model generated by training with positioning map data including all of the buildings, (2) a trained machine learning positioning model generated by training with positioning map data of all of the floors of each of the buildings, and (3) a trained machine learning positioning model generated by training with positioning map data including all regional coordinates of each of the floors. Different parameters can be used during the trainings of the trained machine learning positioning models according to the amount of data covered by the corresponding application scope.

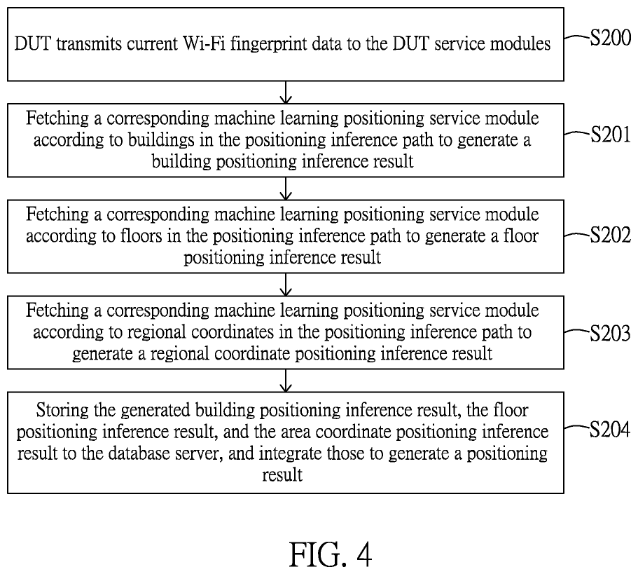

In the above-mentioned way, the positioning inference path PAT sequentially planned by buildings, floors and area coordinates can be obtained. Therefore, when the DUT 12 captures the current WI-FI® fingerprint data, the DUT 12 can be located, for example, through the following positioning process. FIG. 4 is a flowchart of a positioning process according to an embodiment of the present disclosure. As shown in FIG. 4, the positioning process includes the following steps:

Step S200: The DUT transmits current WI-FI® fingerprint data to the DUT service modules. The current WI-FI® fingerprint data can include a number of WI-FI® access points, signal strength indicators RSSIs of the WI-FI® access points, channel information of the WI-FI® access points, and characteristic information generated during a communication process with the WI-FI® access points.

Step S201: Fetching a corresponding machine learning positioning service module according to the buildings in the positioning inference path PAT to generate a building positioning inference result.

Step S202: Fetching a corresponding machine learning positioning service module according to the floors in the positioning inference path PAT to generate a floor positioning inference result.

Step S203: Fetching a corresponding machine learning positioning service module according to regional coordinates in the positioning inference path PAT to generate a regional coordinate positioning inference result.

Step S204: Storing the generated building positioning inference result, the floor positioning inference result, and the area coordinate positioning inference result to the database server, and integrate those to generate a positioning result.

Therefore, the positioning system for integrating machine learning positioning models and the method for the same provided by the present disclosure can perform modular management for multiple machine learning positioning models, and perform hierarchical positioning according to the positioning inference path to fetch multiple machine learning positioning models suitable for different positioning ranges, such that a positioning accuracy can be improved, and time required for calculation can be reduced.

In addition to utilizing the above-mentioned multi-level machine learning positioning service modules to perform calculations on the current input WI-FI® fingerprint data, the positioning accuracy can be further improved by determining presence or absence of specific signals. For example, in the embodiment shown in FIG. 2, the management service module 110 further includes a signal detection module SIGD configured to determine whether at least one specific signal has appeared in the current WI-FI® fingerprint data, thereby narrowing the plurality of positioning inference results based on a specific range associated to the at least one specific signal. For example, for a specific access point that only appears in a specific area, such as a building, floor, or area, the signal provided by the specific access point can be further used to determine that the positioning result only appears in a specific location, so that the positioning inference results can be narrowed to further improve the positioning accuracy.

As shown in FIG. 1, the machine learning positioning service modules 106-1, 106-2, and 106-3 each include access point selection modules APS1, APS2, and APS3 that are configured to filter the current WI-FI® fingerprint data according to a plurality of access point sensing ratio and input the filtered current WI-FI® fingerprint data to the corresponding trained machine learning positioning models.

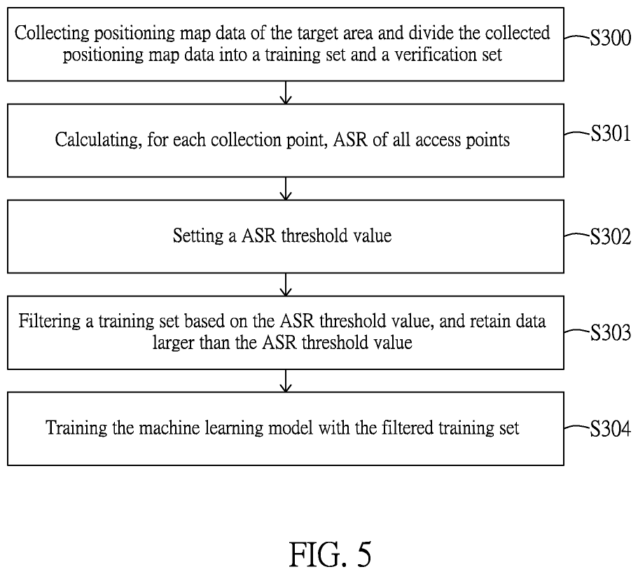

In detail, by setting the access point sensing ratio to train the machine learning positioning model, unnecessary noise can be filtered out and the positioning accuracy can be improved. Reference is made to FIG. 5, which is a flowchart of a training process for a machine learning positioning service module according to an embodiment of the present disclosure.

As shown in FIG. 5, the training process can include the following steps:

Step S300: Collecting positioning map data of the target area and divide the collected positioning map data into a training set and a verification set. For example, the target area may be an indoor place or building that is predetermined to perform positioning, and the positioning map data can include one or more maps of each of the floors of the place or the building. When the positioning map data is collected, multiple coordinates scattered in the target area can be set as collection points, and WI-FI® fingerprint data is collected on these collection points and stored with coordinates corresponding to the collection points.

Step S301: Calculating, for each collection point, access point sensible ratio (ASR) of all access points. For example, ASR can be calculated by the following equation (1) of:

ASRⱼ=Nⱼ/N Equation (1);

ASRⱼ is the access point sensible ratio of jth one of the access points, Nⱼ is the number of the jth one of the access points received, and N is the total number of samples.

Step S302: Setting an ASR threshold value.

Step S303: Filtering a training set based on the ASR threshold value, and retaining data larger than the ASR threshold value.

Step S304: Training the machine learning positioning model with the filtered training set.

The validation set is input into the machine learning positioning model to evaluate whether the machine learning positioning model achieves the expected positioning accuracy. If the expected positioning accuracy has not been achieved, the machine learning positioning model is adjusted with hyperparameters, and the machine learning positioning model is continuously trained with the training set until the machine learning positioning model passes performance test, and the machine learning positioning model that has passed the performance test will be used as the trained machine learning positioning model.

Referring to Table 1 below, Table 1 shows that a lower 90% error (m) can be obtained when a higher threshold value of the ASR is set.

TABLE 1

| Sample | Filtering rate | 90% error (m) |
|---|---|---|
| Without filtering | x | 2.82 |
| ASR > 0.2 | 77.9% | 2.77 |
| ASR > 0.99 | 94.3% | 2.47 |

In conclusion, the positioning system for integrating machine learning positioning models and the method for the same provided by the present disclosure can perform modular management for multiple machine learning positioning models, and perform hierarchical positioning according to the positioning inference path to fetch multiple machine learning positioning models suitable for different positioning ranges, such that a positioning accuracy can be improved, and time required for calculation can be reduced.

In addition, the positioning system for integrating machine learning positioning models and the positioning method for the same provided by the present disclosure also includes a deployment service module, which can provide users with a concise way through the user interface to apply functions of creation, reading, updating, and deletion on multiple machine learning positioning models to be deployed, thereby reducing the time and labor costs required to deploy different machine learning positioning models.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A positioning system for integrating machine learning positioning models, comprising:
a device under test (DUT) configured to obtain current WI-FI® fingerprint data of a current location; and
a scalable backend subsystem configured to communicate with the DUT, and including:
a database server configured to store a plurality of records of machine learning positioning model data, configuration data and setting data, wherein the setting data defines a positioning inference path;
at least one processing unit;
a plurality of machine learning positioning service modules generated by the at least one processing unit executing the plurality of records of machine learning positioning model data, wherein the positioning inference path defines a fetching sequence of the plurality of machine learning positioning service modules, and the configuration data defines a deployment status of the plurality of machine learning positioning service modules; and
a DUT service module, including a positioning inference module, wherein the positioning inference module is configured to receive the current WI-FI® fingerprint data, and sequentially input the current WI-FI®fingerprint data to the plurality of machine learning positioning service modules according to the positioning inference path, to sequentially obtain a plurality of positioning inference results, and wherein the DUT service module integrates the plurality of positioning inference results to generate a positioning result, and uses the positioning result as the current position of the DUT.

2. The positioning system according to claim 1, wherein the scalable backend subsystem further includes a management service module, and the management service module includes:
a web server, including a user interface; and
a deployment service module, including:
a creation unit configured for the user to deploy a new machine learning positioning model, and store a configuration file related to the new machine learning positioning model to the database server;
a reading unit configured to obtain the deployment status of the plurality of machine learning positioning service modules from the configuration data;
an updating unit configured to update the plurality of machine learning positioning service modules based on the new machine learning positioning model, and update the configuration data with the configuration file; and
a deletion unit configured for the user to delete the machine learning positioning service modules.

3. The positioning system according to claim 2, wherein the management service module further includes a setting module configured for the user to set the positioning inference path based on the new machine learning positioning model and update the setting data.

4. The positioning system according to claim 2, wherein the management service module further includes a signal detection module configured to determine whether or not at least one specific signal has appeared in the current WI-FI® fingerprint data, so as to narrow the plurality of positioning inference results based on a specific range associated to the at least one specific signal.

5. The positioning system according to claim 2, wherein the user interface is configured for the user to upload the new machine learning positioning model to the web server.

6. The positioning system according to claim 1, wherein the plurality of machine learning positioning service modules respectively correspond to a plurality of application ranges, and the positioning inference path is planned according to the plurality of application ranges.

7. The positioning system according to claim 6, wherein the plurality of application ranges includes a plurality of buildings, a plurality of floors corresponding to each of the buildings, and a plurality of areas corresponding to each of the floors.

8. The positioning system according to claim 5, wherein each of the plurality of machine learning positioning service modules includes a trained machine learning positioning model, and has a higher accuracy for corresponding ones of the plurality of application ranges.

9. The positioning system according to claim 7, wherein each of the plurality of machine learning positioning service modules includes an access point selection module configured to filter the current WI-FI® fingerprint data according to a plurality of access point sensing ratios and input the filtered current WI-FI® fingerprint data to the corresponding trained machine learning positioning model.

10. A positioning method for integrating machine learning positioning models, comprising:
configuring a device under test (DUT) to obtain current WI-FI® fingerprint data of a current location;
configuring a scalable backend subsystem to communicate with the DUT, wherein the scalable backend subsystem includes a web server, a database server and at least one processing unit;
configuring the database server to store a plurality of records of machine learning positioning model data, configuration data and setting data, wherein the setting data defines a positioning inference path;
configuring the at least one processing unit to execute the plurality of records of machine learning positioning model data to generate a plurality of machine learning positioning service modules, wherein the positioning inference path defines a fetching sequence of the plurality of machine learning positioning service modules, and the configuration data defines a deployment status of the plurality of machine learning positioning service modules;
configuring a positioning inference module of a DUT service module to receive the current WI-FI® fingerprint data, and sequentially input the current WI-FI® fingerprint data to the plurality of machine learning positioning service modules according to the positioning inference path, to sequentially obtain a plurality of positioning inference results; and
configuring the DUT service module to integrate the plurality of positioning inference results to generate a positioning result and use the positioning result as the current position of the DUT.

11. The positioning method according to claim 10, wherein the scalable backend subsystem further includes a management service module, and the positioning method further comprises:
configuring the web server to provide a user interface; and
configuring the deployment service module to provide:
a creation unit configured for the user to deploy a new machine learning positioning model, and store a configuration file related to the new machine learning positioning model to the database server;
a reading unit configured to obtain the deployment status of the plurality of machine learning positioning service modules from the configuration data;
an updating unit configured to update the plurality of machine learning positioning service modules based on the new machine learning positioning model, and update the configuration data with the configuration file; and
a deletion unit configured for the user to delete the machine learning positioning model services.

12. The positioning method according to claim 11, wherein the management service module further includes a setting module, and the positioning method further comprises:
configuring the setting module to set the positioning inference path based on the new machine learning positioning model and update the setting data.

13. The positioning method according to claim 11, wherein the management service module further includes a signal detection module, and the positioning method further comprises:
configuring the signal detection module to determine whether or not at least one specific signal has appeared in the current WI-FI® fingerprint data, thereby narrowing the plurality of positioning inference results based on a specific range associated to the at least one specific signal.

14. The positioning method according to claim 11, further comprising configuring the user interface to upload the new machine learning positioning model to the web server.

15. The positioning method according to claim 10, wherein the plurality of machine learning positioning service modules respectively correspond to a plurality of application ranges, and the positioning inference path is planned according to the plurality of application ranges.

16. The positioning method according to claim 15, wherein the plurality of application ranges includes a plurality of buildings, a plurality of floors corresponding to each of the buildings, and a plurality of areas corresponding to each of the floors.

17. The positioning method according to claim 14, wherein each of the plurality of machine learning positioning service modules includes a trained machine learning positioning model, and has a higher accuracy for corresponding ones of the plurality of application ranges.

18. The positioning method according to claim 16, wherein each of the plurality of machine learning positioning service modules includes an access point selection module configured to filter the current WI-FI® fingerprint data according to a plurality of access point sensing ratios and input the filtered current WI-FI® fingerprint data to the corresponding trained machine learning positioning model.
